(19) United States
(12) Patent Application Publication
(10) Pub. No.: US 2017/0157677 A1
(43) Pub. Date: Jun. 8, 2017

(54) WHEEL MACHINING TECHNOLOGY

(71) Applicant: CITIC Dicastal CO., LTD, Qinhuangdao (CN)

(72) Inventors: Minghua Liu, Qinhuangdao (CN); Weidong Liu, Qinhuangdao (CN); Jiandong Guo, Qinhuangdao (CN); Xiaoguang Huang, Qinhuangdao (CN); Huiying Liu, Qinhuangdao (CN); Zhiyuan Yu, Qinhuangdao (CN); Ruixiao Zhou, Qinhuangdao (CN); Song Li, Qinhuangdao (CN)

(73) Assignee: CITIC Dicastal CO., LTD, Qinhuangdao (CN)

(21) Appl. No.: 15/363,552

(22) Filed: Nov. 29, 2016

(30) Foreign Application Priority Data
Dec. 3, 2015 (CN) 201510876816.5

(51) Int. Cl. B23B 5/28

(52) U.S. Cl. CPC B23B 5/28; B60B 2310/228; B60B 2900/313; B60B 2900/133; B23B 2215/08

(57) ABSTRACT

The present invention discloses a wheel machining technology in which blank quantity is furthest removed by using a 90-degree external turning tool. Under the premise that the rotation direction of a wheel is unchanged, an upper trench of a groove is processed by using a left-handed special cutting-off cutter. Under the premise that the rotation direction of the wheel is unchanged, a lower trench of the groove is processed by using a right-handed special cutting-off cutter. The left-handed special cutter and the right-handed special cutter are added to the wheel machining technology disclosed by the present invention, so as to complete the processing of a groove of an outer wheel rim; a processing program can be pre-edited, so that processed effects conform to the design requirements of drawings of products.

### CROSS-REFERENCE TO RELATED APPLICATIONS

This application claims priority to Chinese Patent Application No. 2015108768165, filed on Dec. 3, 2015, which is hereby incorporated by reference in its entirety.

### TECHNICAL FIELD

The present invention relates to a machining technology, and in particular to a machining technology for automobile parts.

### BACKGROUND ART

With the continuous development of automobile industry, automobile users have higher and higher requirements for the comfort of driven automobiles. Wheels can encounter various different road conditions in the operating course, which puts forward higher requirements for shock absorption and noise resistance of the wheels. Therefore, wheels with special wheel rim structures are produced, e.g., a muffler can be placed in a circumferential groove formed in the outer wheel rim of a wheel, so that noises produced during travelling of the wheel can be reduced, and besides, resonance is correspondingly reduced. When the outer wheel rim is designed with the circumferential groove, the outer wheel rim cannot be processed with a traditional 90-degree external turning tool.

### SUMMARY OF THE INVENTION

The present invention aims to provide a machining method for an outer wheel rim of a wheel with a circumferential groove.

The machining method disclosed by the present invention comprises the following steps:

(1) arranging cutter receiving points outside an upper trench and an lower trench of a groove, so that cutters do not generate interference in the processing course;

(2) processing a set outer wheel rim processing track by using a 90-degree external turning tool, and in the processing course, furthest removing blank quantity, and enabling the cutters not to generate interference;

(3) under the premise that the rotation direction of the wheel is unchanged, processing the upper trench of the groove by using a left-handed special cutting-off cutter; and

(4) under the premise that the rotation direction of the wheel is unchanged, processing the lower trench of the groove by using a right-handed special cutting-off cutter.

In step (2), the processing of the set track of the outer wheel rim is completed with the forward rotation speed of the wheel being set to 1200-1500 r/min, the rough turning feed rate being 0.40-0.50 mm/r, and the fine turning feed rate being 0.30-0.40 mm/r; after processing according to the set track, a processing quantity of 0.2 mm is reserved to the side wall of the upper trench and the side wall of the lower trench.

In step (3), under the forward rotation speed of the wheel being 1200-1500 r/min, the processing of the upper trench is completed through four times of processing, with the engagement quantity of each time of processing being 0.5 mm, and the feed rate being 0.10-0.20 mm/r.

In step (4), under the forward rotation speed of the wheel being 1200-1500 r/min, the processing of the lower trench is completed through four times of processing, with the engagement quantity of each time of processing being 0.5 mm, and the feed rate being 0.10-0.20 mm/r.

According to the technical scheme, the left-handed special cutter and the right-handed special cutter are added to complete the processing of the groove of the outer wheel rim, and a processing program can be pre-edited, so that processed effects conform to the design requirements of drawings of products.

### DETAILED DESCRIPTION OF THE INVENTION

In the working course, a wheel is mounted and clamped on a computer numerical control machine tool through a fixture, and an electric motor drives a main shaft of the machine tool to rotate, so that the wheel can rotate in a counter-clockwise manner at a definite speed; three cutters are all horizontally mounted and clamped on a cutter tower, to process the outer wheel rim position of the wheel at a definite feed rate according to a pre-edited processing program.

According to the wheel machining technology disclosed by the present invention, firstly blank quantity is furthest removed by using a 90-degree external turning tool, then under the premise that the rotation direction of the wheel is unchanged, an upper trench is processed by using a left-handed special cutting-off cutter, and finally under the premise that the rotation direction of the wheel is unchanged, a lower trench is processed by using a right-handed special cutting-off cutter.

Embodiment 1: when the 90-degree external turning tool is used, the forward rotation speed of the wheel is set to 1200 r/min, the rough turning feed rate is 0.40 mm/r, and the fine turning feed rate is 0.30 mm/r. When the left-handed special cutting-off cutter is used, the forward rotation speed of the wheel is 1200 r/min, the processing of the upper trench is completed through four times of processing, the engagement quantity of each time of processing is 0.5 mm, and the feed rate is 0.10 mm/r. When the right-handed special cutting-off cutter is used, the forward rotation speed of the wheel is 1200 r/min, the processing of the lower trench is completed through four times of processing, the engagement quantity of each time of processing is 0.5 mm, and the feed rate is 0.10 mm/r.

Embodiment 2: when the 90-degree external turning tool is used, the forward rotation speed of the wheel is set to 1400 r/min, the rough turning feed rate is 0.45 mm/r, and the fine turning feed rate is 0.35 mm/r. When the left-handed special cutting-off cutter is used, the forward rotation speed of the wheel is 1300 r/min, the processing of the upper trench is completed through four times of processing, the engagement quantity of each time of processing is 0.5 mm, and the feed rate is 0.15 mm/r. When the right-handed special cutting-off cutter is used, the forward rotation speed of the wheel is 1300 r/min, the processing of the lower trench is completed through four times of processing, the engagement quantity of each time of processing is 0.5 mm, and the feed rate is 0.15 mm/r.

Embodiment 3: when the 90-degree external turning tool is used, the forward rotation speed of the wheel is set to be 1500 r/min, the rough turning feed rate is 0.5 mm/r, and the fine turning feed rate is 0.4 mm/r. When the left-handed special cutting-off cutter is used, the forward rotation speed of the wheel is 1500 r/min, the processing of the upper trench is completed through four times of processing, the engagement quantity of each time of processing is 0.5 mm, and the feed rate is 0.2 mm/r. When the right-handed special cutting-off cutter is used, the forward rotation speed of the wheel is 1500 r/min, the processing of the lower trench is completed through four times of processing, the engagement quantity of each time of processing is 0.5 mm, and the feed rate is 0.2 mm/r.

What is claimed is:

1. A wheel machining technology, characterized by comprising the following steps: (1) arranging cutter receiving points outside an upper trench and a lower trench of a groove, so that cutters do not generate interference in the processing course; (2) processing a set outer wheel rim processing track by using a 90-degree external turning tool, and in the processing course, furthest removing blank quantity, and enabling the cutters not to generate interference; (3) under the premise that the rotation direction of a wheel is unchanged, processing the upper trench of the groove by using a left-handed special cutting-off cutter; and (4) under the premise that the rotation direction of the wheel is unchanged, processing the lower trench of the groove by using a right-handed special cutting-off cutter;
in step (2), the processing of the set track of the outer wheel rim is completed with the forward rotation speed of the wheel being set to 1200-1500 r/min, the rough turning feed rate being 0.40-0.50 mm/r, and the fine turning feed rate being 0.30-0.40 mm/r; after processing according to the set track, the processing quantity of 0.2 mm is reserved to the side wall of the upper trench and the side wall of the lower trench;
in step (3), under the forward rotation speed of the wheel being 1200-1500 r/min, the processing of the upper trench is completed through four times of processing, with the engagement quantity of each time of processing being 0.5 mm, and the feed rate being 0.10-0.20 mm/r; and
in step (4), under the forward rotation speed of the wheel being 1200-1500 r/min, the processing of the lower trench is completed through four times of processing, with the engagement quantity of each time of processing being 0.5 mm, and the feed rate being 0.10-0.20 mm/r.

2. The wheel machining technology according to claim 1, characterized in that: when the 90-degree external turning tool is used, the forward rotation speed of the wheel is set to 1200 r/min, the rough turning feed rate is 0.40 mm/r, and the fine turning feed rate is 0.30 mm/r; when the left-handed special cutting-off cutter is used, the forward rotation speed of the wheel is 1200 r/min, and the feed rate is 0.10 mm/r; and when the right-handed special cutting-off cutter is used, the forward rotation speed of the wheel is 1200 r/min, and the feed rate is 0.10 mm/r.

3. The wheel machining technology according to claim 1, characterized in that: when the 90-degree external turning tool is used, the forward rotation speed of the wheel is set to 1400 r/min, the rough turning feed rate is 0.45 mm/r, and the fine turning feed rate is 0.35 mm/r; when the left-handed special cutting-off cutter is used, the forward rotation speed of the wheel is 1300 r/min, and the feed rate is 0.15 mm/r; and when the right-handed special cutting-off cutter is used, the forward rotation speed of the wheel is 1300 r/min, and the feed rate is 0.15 mm/r.

4. The wheel machining technology according to claim 1, characterized in that: when the 90-degree external turning tool is used, the forward rotation speed of the wheel is set to 1500 r/min, the rough turning feed rate is 0.5 mm/r, and the fine turning feed rate is 0.4 mm/r; when the left-handed special cutting-off cutter is used, the forward rotation speed of the wheel is 1500 r/min, and the feed rate is 0.2 mm/r; and when the right-handed special cutting-off cutter is used, the forward rotation speed of the wheel is 1500 r/min, and the feed rate is 0.2 mm/r.
